(19) United States
(12) Patent Application Publication
(10) Pub. No.: US 2003/0035075 A1
(43) Pub. Date: Feb. 20, 2003

(54) Method and system for providing improved user input capability for interactive television

(76) Inventors: Michelle A. Butler, Kirkland, WA (US); Robert E. Novak, Kirkland, WA (US)

Correspondence Address: DIGEO, INC C/O STOEL RIVES LLP, 201 SOUTH MAIN STREET, SUITE 1100, ONE UTAH CENTER, SALT LAKE CITY, UT, 84111, US

(21) Appl. No.: 09/933,683

(22) Filed: Aug. 20, 2001

(51) Int. Cl. G06F 3/00; H04N 5/445; G06F 13/00; H04N 7/173; H04N 5/44

(52) U.S. Cl. 348/734; 725/37; 725/38; 725/109; 725/110; 725/133

(57) ABSTRACT

A system and a method for accessing interactive content by providing touch screen capability on interactive television systems and associated remote control devices are disclosed. Embodiments provide interactive capability by using a touch screen rather than a mouse or a standard remote control device. However, this specific embodiment is merely illustrative of the many various methods, apparatuses, systems, and computer program product embodiments accorded by the present invention.

### BACKGROUND OF THE INVENTION

The present invention relates generally to techniques for providing interactive experiences to viewers of television, and in particular to techniques for providing user input capability for interactive program content over television.

At a time when many in our society are enjoying increasing productivity in their work environment, in large part the benefit of the investment in new technology, somewhat paradoxically, leisure time has become a premium commodity. Sadly, free time to enjoy entertainment, or to shop for goods for ones self or others has become a scarce luxury. It seems that every day, demands on the individual and the family arise, barring the enjoyment of quality time together. Accordingly, Americans seek more easily enjoyed forms of entertainment than ever before in history.

One type of entertainment device that has experienced wide acceptance is the television. Television has become one of the most widespread mediums for broadcasting content to a viewer. Almost every house in the United States and in most other developed countries has access to a television. Families congregate around the television to enjoy movies, sitcoms, instructional programming, comedy shows, and more. Conventional television may receive its signals from a content broadcast source via cable, satellite, antenna, or other device. The channels are “tuned” either by the television itself or by a set top box. Content is provided by a plurality of content broadcast sources, in return for advertising revenue. One of the ways a content broadcast source derives revenue is through the sale of time slots for commercial advertising. A company promoter pays for a time slot during a particular broadcast, such as a movie or a sitcom, to promote a company product. The company promoter relies on the power of the advertisement to motivate each viewer either to travel to a store to purchase the product or to order the product via telephone or Internet connection.

One recent advance to television technology is the onset of interactive television and web-enabled television. These technologies enable a viewer to select content, to view content, to request information pertaining to content, to identify preferred advertising, to access web content, to access video game downloads, and more. Interactive television provides a more attractive entertainment medium than the traditional television.

While certain advantages to conventional approaches are perceived, opportunities for further improvement exist. For example, according to conventional television technology, a variety of people of different ages, demographics, and motor skills use the same devices to interact with a television program. According to conventional approaches, viewers provide input via a remote control device. The remote control is typically a hand held device that communicates with the television apparatus and/or a set top box by an Infrared (IR) or other link. However, many of the viewers may possess disparate motor skills, or visual capabilities. For example, children may develop interest in interacting with televised program content before they are in possession of sufficient motor skills to use a remote control. Elders, or physically impaired individuals may have lost some of the requisite motor skills to work with a remote control, yet have an interest in interactive program content. Further, persons having reduced visual capabilities may also enjoy some types of interactive program content, such as text to speech conversion of books, or other written materials. Conventional input mechanisms typically are not tailored to these persons' particular capabilities, and do little to enhance such persons' enjoyment of interactive program content.

What is needed are improved techniques for providing information to interactive entertainment and educational program content.

### BRIEF DESCRIPTION OF THE DRAWINGS

Non-limiting and non-exhaustive embodiments of the present invention are described with reference to the following figures, wherein like reference numerals refer to like parts throughout unless otherwise specified.

FIG. 1A illustrates a block diagram of a representative example interactive television system in a specific embodiment of the present invention.

FIG. 1B illustrates a block diagram of another representative example interactive television system in a specific embodiment of the present invention.

FIG. 1C illustrates a block diagram of a still further representative example interactive television system in a specific embodiment of the present invention.

FIG. 2A illustrate block diagram of a representative example system for providing interactive television content in a specific embodiment of the present invention.

FIG. 2B illustrates a block diagram of another representative example system for providing interactive television content in a specific embodiment of the present invention.

FIG. 2C illustrates a block diagram of a further representative example system for providing interactive television content in a specific embodiment of the present invention.

FIG. 2D illustrates a block diagram of a still further representative example system for providing interactive television content in a specific embodiment of the present invention.

FIG. 3A illustrates a block diagram of a representative set top box in a specific embodiment of the present invention.

FIG. 3B illustrates a block diagram of an example computing system suitable for embodying one or more components in various specific embodiments of the present invention.

FIGS. 4A-4D illustrate flowcharts of representative processing flows in various specific embodiments of the present invention.

FIGS. 5A-5B illustrate representative screen displays in various specific embodiments of the present invention.

FIG. 6 illustrates a diagram of a representative remote control device in a specific embodiment of the present invention.

### DESCRIPTION OF THE SPECIFIC EMBODIMENTS

The present invention provides improved techniques for accessing interactive content by providing touch screen capability on interactive television systems and associated remote control devices. Embodiments provide interactive capability by using a touch screen rather than a mouse or a standard remote control device. For example, specific embodiments of the present invention employ presence sensitive devices to receive tactile input to permit interactive media experiences with electronic program content via television. In specific embodiments, the presence sensitive device can be a touch screen, capacitive touch screen, a surface acoustic wave (SAW) touch screen, a wire resistive touch screen, a stylus based selection indication mechanism, and the like. In an example embodiment, a touch screen emulates the operation of a mouse to select areas of the screen to activate. Specific embodiments may be preferably implemented on a television, a remote control, or the like.

Specific embodiments provide touch access to interactive media, such as story telling and game software available on CD ROM, DVD, and other popular formats. Touch access enables specific embodiments to be especially suitable for children or adults with impaired motor abilities because children instinctively touch something they want and using a touch screen is much easier than using a mouse or a device with small buttons, such as a standard remote control, for a disabled person. Further, small children, who are the typical users of story telling software, lack the fully developed motor ability to operate a mouse or a complicated control device. People with impaired vision capabilities may use a touch screen to enlarge an area or have the text read to them by the interactive system.

In a representative embodiment, the interactive program content provided by an interactive television system in a specific embodiment, varies from an electronic program guide (EPG) that permits the user select a program for viewing, to contents involving greater sophistication, such as an interactive tutor, educational programs, an electronic program guide for children, an on-screen control for television, an on-screen control for a displayed cursor, an on-screen control for VCR, an interactive game, interactive educational instruction, interactive foreign language instruction, interactive decision making for creating a story, and the like. An EPG designed for a child may include colorful diagrams of images that are familiar to the child, presented at a size that is suitable for the child's hand. The EPG may further include accompanying audio introducing the programs. The EPG may list the regular children's programming available from the television broadcast center or may refer to prerecorded programs by the parents of the child.

In another embodiment, an interactive children's book may be provided with an area on the screen that allows the child to thumb through the pages or further explore a character or an object depicted on the page. For example, in one embodiment, an interactive educational program may be designed to teach the child how to read. In another example embodiment, text to speech capability may be incorporated to read books to the children or present a visually impaired person with an audio version of what he is viewing. The user will have the capability to speed up or slow down the delivery of a narration. Animation of the content is another option. The user may command animation via the touch screen and touching a word will cause the program to show the meaning of the word. In specific embodiments, information can be received from the viewer, or another, and be incorporated within the interactive program. For example, the name of a child viewer and/or the names of the friends of a child viewer can be inserted into the story line. A picture of the child can be obtained either from a digital camera or other means, and incorporated into the story. This information can be stored in a variety of ways in various specific embodiments. For example, the information can be incorporated into fields within the story, either at run time, or in an initialization process prior to running the program.

In other representative embodiments, appropriate content is provided to adults who cannot easily use a remote control or a mouse. An adult EPG, games, books, educational programs, and the like, may be presented to the viewer and accessed using a presence sensitive capability. In yet other representative embodiments, the interactive capability may be used for buying goods and services. By touching an appropriate area corresponding to a buy button on a remote control, the viewer can initiate a transaction to purchase goods or services, for example. In another example embodiment, the content may be foreign language audio programs that present both an audio and the text that accompanies the audio.

In another embodiment, if the PVR (personal video recorder) is playing a recorded content, pauses may be inserted in the recorded content that cause the system to move into the interactive mode and for example permit a child to count the objects on the screen and press the area corresponding to the correct answer on the touch screen. Certain triggers may be embedded into an interactive broadcast program that would cause the PVR to pause the program and allow the child to perform the activity requested interactively at his or her own pace before continuing to the next part of the program.

In various embodiments, the touch screen capability may be provided through the monitor itself or remotely. For example, in one specific embodiment, the remote control will also include touch screen capability. In one embodiment, the remote control will include a version of the image presented by the television. The image may be scaled down, compressed, or modified to permit display on the remote control of a reasonable size. In a representative embodiment, the operation of the remote control may emulate a mouse; in order to assist small children to more quickly learn to use the web.

The content provided to the user may be purchased or rented and available in the user's personal library or may come to the user online, or via broadcast or cable. In various embodiments, the source of the content may be any of a wide variety of sources, such as an interactive television broadcast source, the Internet, a satellite broadcast source, a cable network, user's own library of video tapes, CD ROMs or DVDs. The content may be augmented for example by taking a picture of the child and inserting it in the story line.

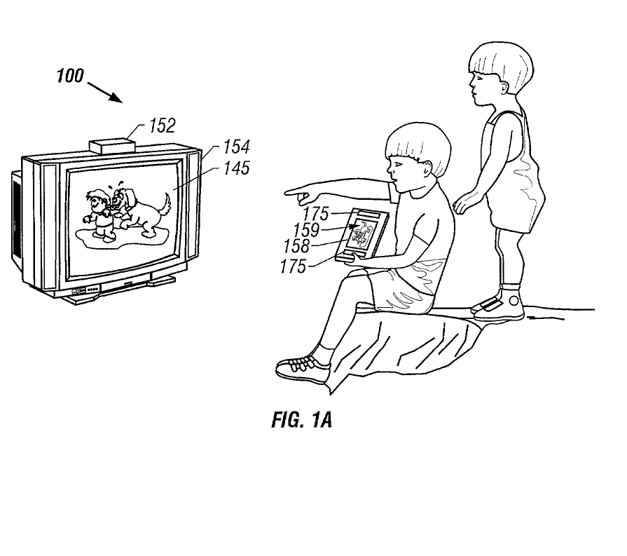

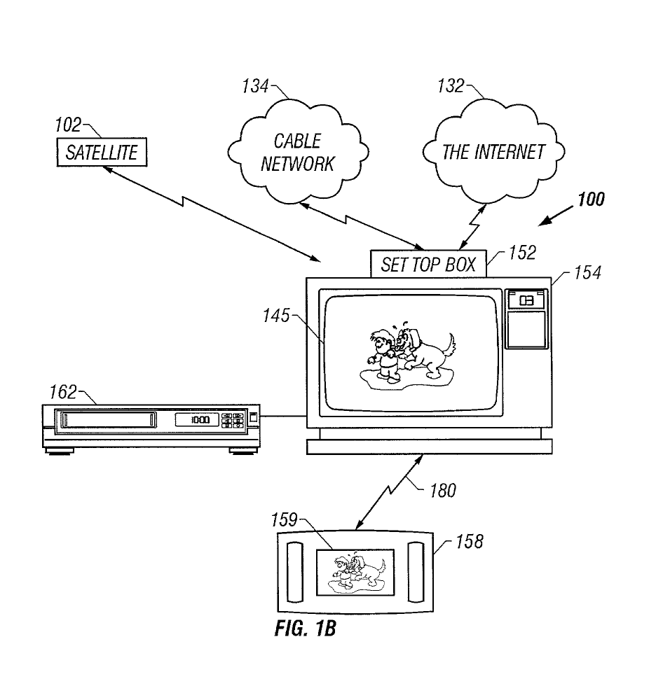

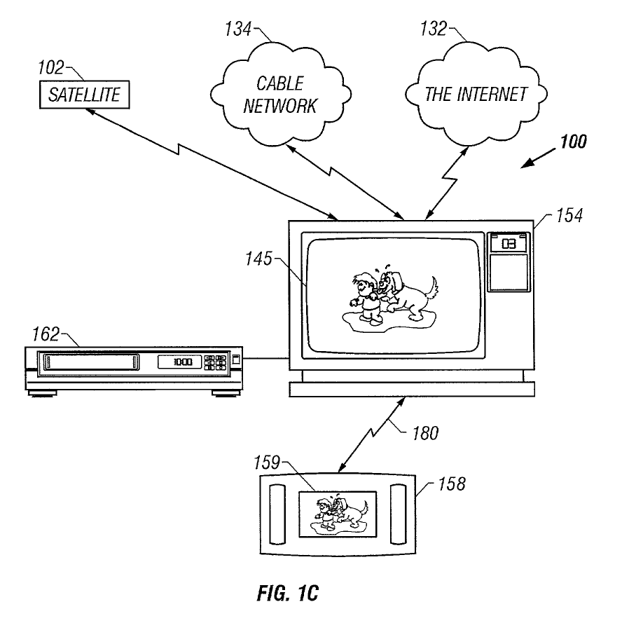

FIG. 1A illustrates a block diagram of a representative example interactive television system in a specific embodiment of the present invention. In the specific embodiment shown in FIG. 1A, representative example interactive television system 100 comprises a television monitor 154 with the touch screen overlay 145. An optional associated remote control 158, which can optionally have a corresponding touch screen overlay 159 can be provided. In specific embodiments, the remote control 158 can display the same image as the television monitor 154 and can be small enough for a child to hold in his or her lap. However, in other specific embodiments, the remote control 158 can display content in addition to, or different from, the content displayed by the television 154. The remote control 158 has one or more handles 175 that enable the remote control 158 to be easily grasped by children or disabled adults. The handles depicted are intended to serve only as representative of the concept that the remote control 158 is of a type that is easily handled by people with limited motor ability, and accordingly, not intended to limit the present invention.

In specific embodiments, interactive television system 100 may provide interactivity to users, such as permitting the user to select a program, turn the system on and off, and the like. Such capabilities may be provided using an EPG displayed on the screen of television 154 and/or on the remote control 158. A desired program may be selected by touching a corresponding listing on the touch screen 145 attached to the monitor of the television set 154 or by touching the corresponding screen 159 on the remote control 158.

In specific embodiments, interactive television system 100 may also provide other interactive functionality, such as, displaying a children's story book to the user. According to various specific embodiments, the content of the story book for display may be provided from one or more of a prerecorded medium, such as a CD-ROM, that is played by a playback device 162, such as a CD ROM player, connected to the television set, or from a satellite provider 102, a cable network 134, or the Internet 132. A child user may thumb through the book by touching the appropriate area on either the television screen 145 or the screen of the remote control 158. The child may ask the book to provide audio feedback by touching the appropriate areas or may get more information regarding a certain character or a certain item by touching the character or the item. For example, touching the sun depicted on a page of the book in FIG. 1A may play an audio feedback telling the child more about the sun and its properties. The pictures and areas depicted by the story book operate similarly to the hotlinks of an Internet website and take the user to other related areas.

FIG. 1B illustrates a block diagram of another representative example interactive television system in a specific embodiment of the present invention. The system 100 of the specific embodiment illustrated in FIG. 1B includes a set top box 152 connected to the television set 154. The television set 154 is equipped with the touch screen 145 and is communicatively coupled to remote control device 158 having touch screen 159. The television 154 or the remote control 158 may be linked to the set top box 152 via communication connection 180, which may be a wireless or wire connection in various specific embodiments. Interactive program content can be received from one or more of a variety of providers in various specific embodiments. For example, FIG. 1B illustrates a subset of some of the many possible sources of interactive program content available in various specific embodiments. For example, some of the many possible sources of content include, an Internet web site 132, a cable television content provider 134, a satellite television content provider, and a provider of recorded interactive program content, which can be reproduced using a device having playback capabilities 162. Interactive program content can be recorded on a variety of popular topologies, such as disk, tape, semiconductor memory, and the like, in a variety of formats, such as CD-ROM, DVD, VCR, PVR, and the like.

FIG. 1C illustrates a block diagram of a still further representative example interactive television system in a specific embodiment of the present invention. In the specific embodiment illustrated by FIG. 1C, the television set 154 is equipped with necessary functionality to provide interactive program content, obviating any additional set top box. The touch screen 145 is operatively coupled with the television 154. Further, a remote control device 158 having touch screen 159 may be communicatively coupled with the television 154. The television 154 or the remote control 158 may be linked to the set top box 152 via communication connection 180, which may be a wireless or wire connection in various specific embodiments. Accordingly, the features and functionality described herein with respect to embodiments employing a set top box are also equally applicable to embodiments such as that illustrated by FIG. 1C, which operate without an external set top box unit. Such embodiments can be used with one or more of a wide variety of sources for interactive program content, such as an Internet web site 132, a cable television content provider 134, a satellite television content provider, and a provider of recorded interactive program content, which can be reproduced using a device having playback capabilities 162. Interactive program content can be recorded on a variety of popular topologies, such as disk, tape, semiconductor memory, and the like, in a variety of formats, such as CD-ROM, DVD, VCR, PVR, and the like.

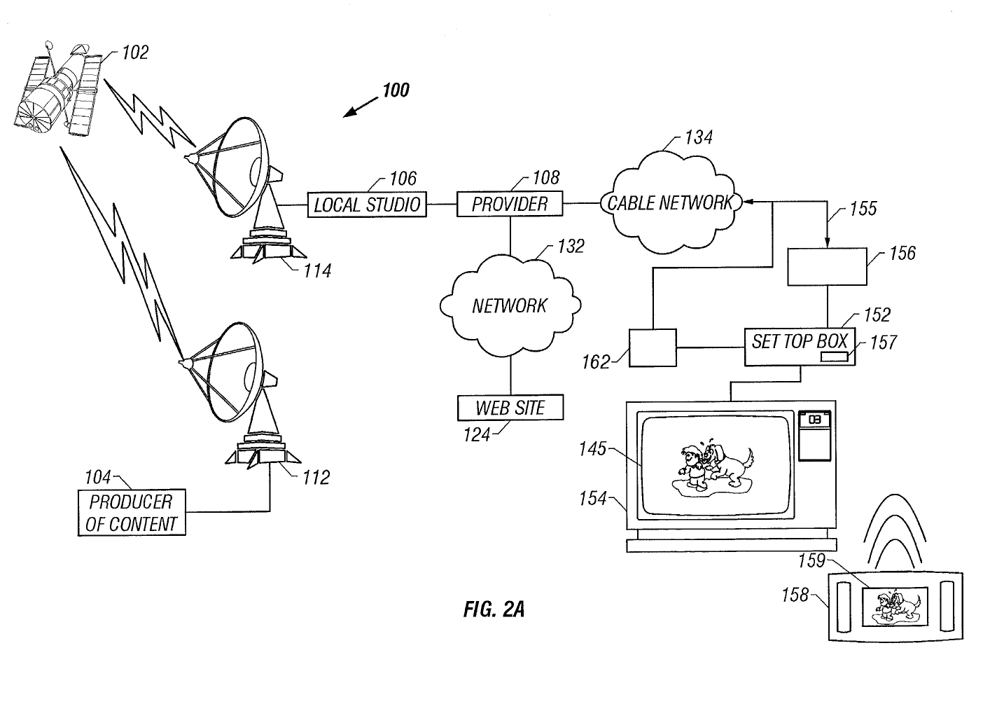

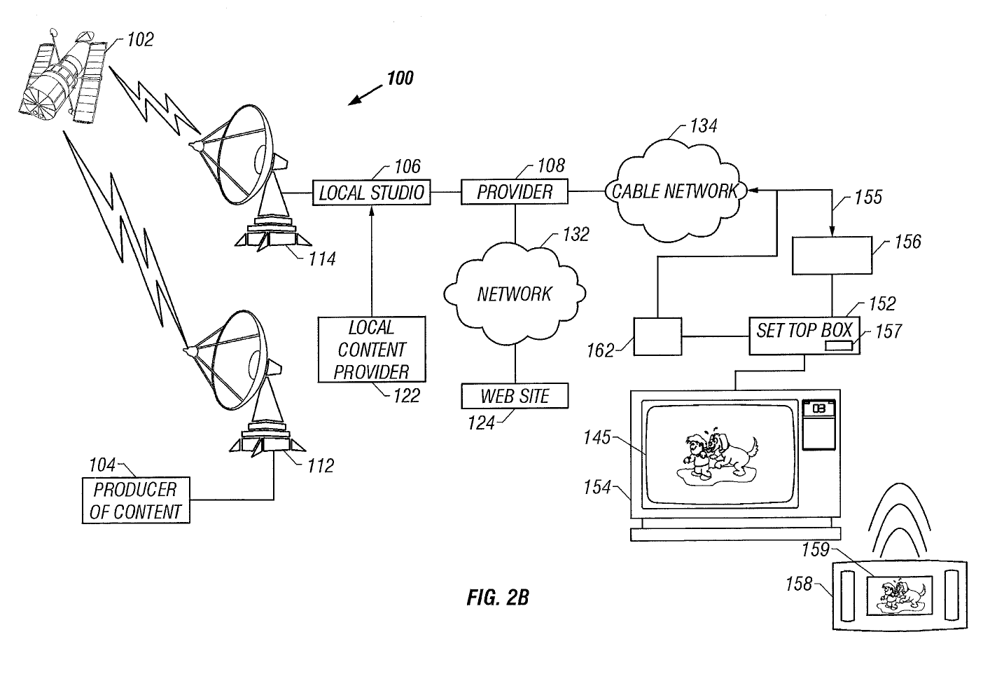

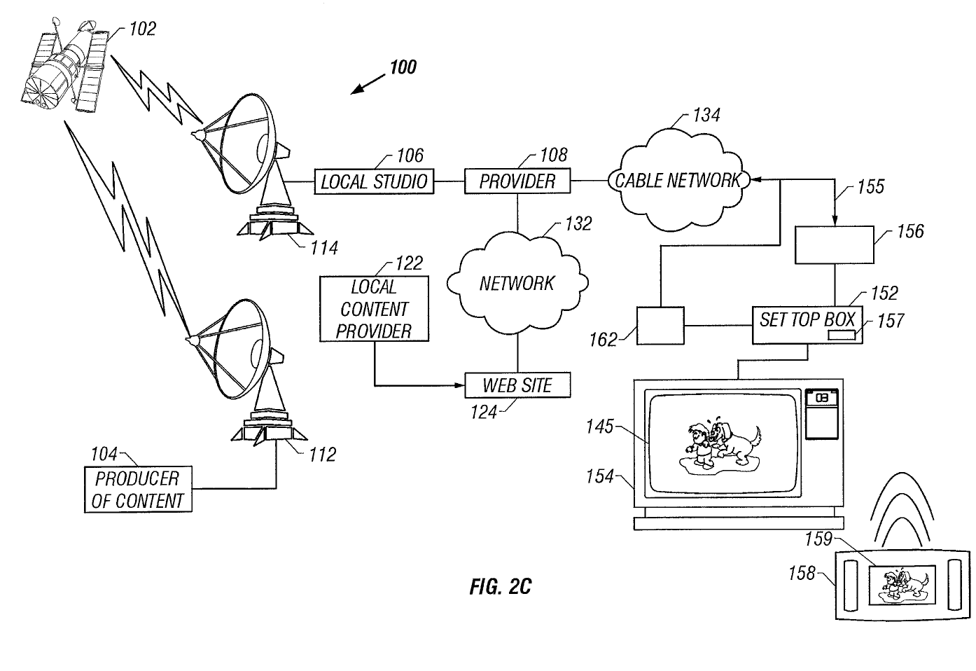

FIG. 2A illustrates a block diagram of a representative example system for providing interactive television content in a specific embodiment of the present invention. As shown in FIG. 2A, representative interactive television system 100 comprises a production company 104 that produces programming content for transmission to viewers. This programming content is sent via satellite transmission transceiver 112 over an uplink channel to a satellite 102. The satellite 102 then transmits the programming content over a downlink channel via a satellite transmission transceiver 114 to a local studio 106, or alternatively to a cable service provider 108. The local studio 106 can insert additional programming (e.g., regional programming) and/or advertisements as needed into the programming content. The content with the insertions is then transmitted from the local studio 106 to a cable service provider 108. The television program may be downloaded to a receiving station, such as a head-end (H/E) (not shown) of the cable service provider 108, rather than or in addition to the local studio 106. In some specific embodiments, a reverse channel from the cable service provider 108 to the local studio 106 is provided so that the local studio 106 can insert additional programming content and feed the television signal back to the cable service provider 108. The cable service provider 108 then delivers the television signal over a cable network 134 to cable subscribers. In various alternative embodiments, the cable network 134 may comprise a digital subscriber line (DSL), cable TV, or satellite dish delivery system. Commands and requests by the user may be conveyed to the content provider via the same route.

The cable network 134 is provided by the cable service provider 108 to distribute the programming content to cable subscribers. A set top box (STB) 152, typically located on the premises of a cable television subscriber, receives the programming content or television signal from cable network 134, and delivers the television signal to the subscriber's television set 154. In some specific embodiments, alternatively or in addition, the television signal can be broadcast over a wireless medium and received by a traditional aerial antenna or by a satellite dish, and then delivered to the set top box 152. Alternatively or additionally, features and functionality of the set top box 152 may be integrated into a type of advanced television or other display device.

Moreover, in specific embodiments, other types of broadcast media, including but not limited to, digital cable systems, satellite, very-high-data-rate digital subscriber line (VDSL), web casts, and the like may be used to carry programming content. The features provided by the television set 154 can also be provided, in a specific embodiment, by a personal computer (PC) suitably configured with an adapter to convert television signals into a digitized format, and then to deliver the television signals to the video portion of the computer for display. It is noted that the invention is not limited to any one configuration of display hardware as embodiments of the invention can be realized using alternative reception and display arrangements, as known to those skilled in the art.

In accordance with an embodiment of the invention, a connection to a communication network is provided for a subscriber to cable services. In one embodiment, the connection can be made via a cable modem 156 over a bi-directional communication link 155 to a cable modem termination system within the cable provider's 108 equipment. The cable provider's 108 equipment provides connection to a data communication network, such as the Internet, by way of a network 132. In a representative example embodiment, the network 132 is a public switched telephone network (PSTN), however, other types of networks, such as computer networks, the Internet, and the like, may be used. In a specific embodiment, a cable modem arrangement can be used to provide connection to the network 132 because of its high bandwidth capability. In situations where some cable companies are not equipped to provide cable modem service to their customers, various other arrangements known to those skilled in the art can be used. For example, a conventional modem connection can be used to access the Internet over a telephone line. As another example, Internet access can be provided using a Digital Subscriber Line (DSL) connection, or an integrated services digital network (ISDN) connection, using a telephone line. Wireless systems are also available for providing Internet access. In a specific embodiment, downstream data transmission may occur via cable or satellite, and upstream data transmission may occur via a telephone line. While the Internet may be used as data communication network 132 because the Internet is a well-established network, and connectivity to the Internet is easily made, a global network, such as the Internet, is not required to practice other embodiments of the invention. Accordingly, a locally provided and maintained network may be used in another specific embodiment of the invention.

In specific embodiments, the set top box 152 can include a transceiver 157, such as an infrared (IR) or radio frequency (RF) transceiver, that can exchange signals with a remote control unit 158, a presence sensitive device 145 disposed in front of the viewing screen of television 154, and/or a presence sensitive device 159 disposed in front of the viewing screen of the remote control 158, or other user input device. In specific embodiments, the set top box 152 can be a component separate from the television set 154 as shown in FIG. 2A, or its features can be built into circuitry of the television set 154. The set top box 152 enables a viewer to select a television program to view and then delivers the television program to the television set 154. A playback device 162 can also be coupled to or be a part of the set top box 152. The playback device 162 can include a machine-readable storage medium such as a cache, buffer, memory, diskette, compact disk, tape, or the like and their associated hardware, in a specific embodiment. In another embodiment the playback device 162 can include a videocassette recorder (VCR). In further embodiments, the interactive program content can be provided by one or more of a hard disk, such as a digital or personal video recorder, a DVR, a VCR a DVD player, a CD player, a PVR, a Nintendo, a Playstation, a set top box, and a head end computer.

As noted above, the local studio 106 can insert additional programming into the received transmission; for example, to provide cable content that includes locally provided channels. The programming is then distributed to customers over the cable network 134. In addition to local program insertion, the local studio 106 can insert advertising content, product supplemental information, including information relating to the goods or services being advertised in a commercial, and so forth. Triggers, such as Advanced Television Enhancement Forum (ATVEF) triggers, which are related to the web site 124 and/or to its contents, can be continuously updated as the television broadcast is being received. As noted above, the triggers, resources, or announcements can be inserted by the originating broadcaster 104, a local broadcaster 106, or by the cable system operator 108. For example, in a specific embodiment, one or more triggers may be embedded into a broadcast program content to cause a PVR to pause program. This allows a viewer to interact with the program at his or her own pace, and subsequently, to continue viewing the program at a subsequent part.

In some specific embodiments, programming content is provided from a satellite TV delivery system, which may comprise a direct broadcast satellite (DBS) system. In a specific embodiment, a representative DBS system may comprise a small 18-inch, for example, satellite dish, which is an antenna for receiving a satellite broadcast signal; a digital integrated receiver/decoder (IRD), which separates each channel, and decompresses and translates the digital signal so that television 154 can show it under control of set top box 152 and remote control 158.

In specific embodiments, multiple high-power satellites 102 in geosynchronous orbit may distribute programming for a DBS system, for example. Each satellite 102 has multiple transponders. Compression (e.g., MPEG) is used to increase the amount of programming that can be transmitted in the available bandwidth in specific embodiments. A digital broadcast center may be used to gather programming content, ensure its digital quality, and transmit the signal up to the satellites.

Programming may come to the broadcast center from content providers 104 (TBS, HBO, CNN, ESPN, and so forth) via satellite, fiber optic cable and/or special digital tape. Satellite-delivered programming may be digitized, encrypted and up linked to the orbiting satellites. The satellites retransmit the signal back down to earth stations, which comprise compatible DBS system receiver dishes at customers' homes and businesses.

Some programs may be recorded on digital videotape in the broadcast center to be broadcast later. Before customers may view recorded programs, technicians may use post-production equipment to view and analyze each tape to ensure audio and video quality. Tapes may then be loaded into a robotic tape handling systems, for example, and playback may be triggered by a computerized signal sent from a broadcast automation system. Back-up videotape playback equipment and the like, may ensure uninterrupted transmission at all times.

As used herein, the term “broadcast center” is to be broadly construed to include either a broadcast center for satellite delivery or a cable distribution head-end.

FIG. 2B illustrates a block diagram showing a further example of an interactive video casting system in a specific embodiment of the present invention. As shown by FIG. 2B, interactive video casting system 100 includes a local content provider 122, which may be co-located with local studio 106, or at another location. In one specific embodiment, a bi-directional communication line 155 and a cable modem 156 can be used to couple a set top box 152 to a cable modem termination system within the cable provider's 108 equipment. The cable provider's 108 equipment provides connection to a data communication network, such as the Internet, by way of a network 132. In specific embodiments, the set top box 152 can include a transceiver 157, such as an infrared (IR) or radio frequency (RF) transceiver, that can exchange signals with a remote control unit 158, a presence sensitive device 145 disposed in front of the viewing screen of television 154, and/or a presence sensitive device 159 disposed in front of the viewing screen of the remote control 158, or other user input device.

The set top box 152 can be a component separate from the television set 154 as shown in FIG. 2B, or its features can be built into circuitry of the television set 154 (e.g., an interactive television set). A playback device 162 can also be coupled to or be a part of the set top box 152. The playback device 162 can include a machine-readable storage medium such as a cache, buffer, memory, diskette, compact disk, tape, or the like and their associated hardware, in one embodiment. In another embodiment the playback device 162 can include a videocassette recorder (VCR). In a yet further embodiment, the playback device can include a hard disk such as a digital or personal video recorder (DVR or PVR).

As noted above, in specific embodiments, Internet access is not necessary to practice the invention. A locally provided network may be used to provide communication and program content delivery in specific embodiments of the present invention. The cable provider 108 can supply the foregoing features, for example, by providing a web site or a “walled garden” that is accessed by its subscribers. In such configurations, the cable provider 108 serves as an intermediary and allows the local content provider 122 to interface to set top box 152 in sites to be monitored.

FIG. 2C illustrates a block diagram of a further representative example system for providing interactive television content in a specific embodiment of the present invention. As shown by FIG. 2C, interactive television system 100 includes a web site 124 that is also connected to the network 132. The web site 124 enables a local content provider 122 to provide video and/or audio programming content and/or other information to the home, office, or place of business of the user. Here, the local content provider 122, co-operatively with web site 124, is capable of providing programming content to viewers of the television 154 via network 132. In some specific embodiments, the viewer can use the web site 124 to obtain permission to access specific programming provided by the local content provider 122.

FIG. 2D illustrates a block diagram of a representative example system for providing interactive television content in a specific embodiment of the present invention. As shown by FIG. 2D, interactive television system 100 includes a content provider 122 that distributes programming content incorporated into physical media for use directly in the home, office, or place of business of the viewer. A variety of types of physical media are available for distributing program content. For example, media such as CD ROM, DVD, magnetic tape, flash memory cards, chips, or the like, smart cards, and so forth may be used to contain program content for distribution to the viewer. In a specific embodiment, the program content may be stored in a playback device 162 coupled to or be a part of the set top box 152. The playback device 162 can include a machine-readable storage medium such as a cache, buffer, memory, diskette, compact disk, tape, or the like and their associated hardware, in one embodiment. In another embodiment the playback device 162 can include a videocassette recorder (VCR). In a yet further embodiment, the playback device can include a hard disk such as a digital or personal video recorder (DVR or PVR).

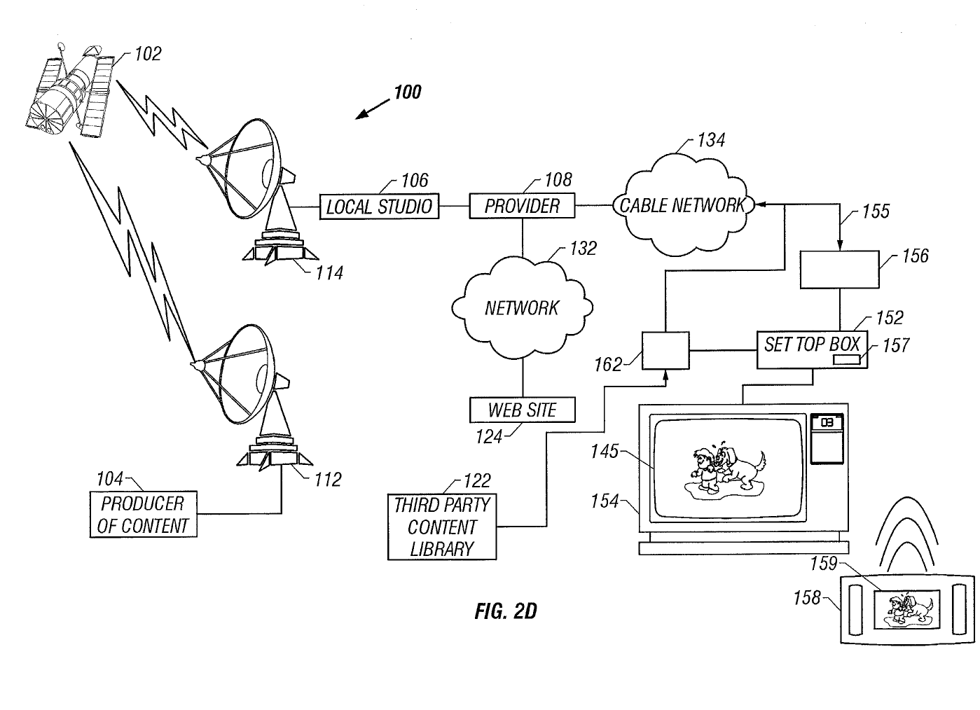

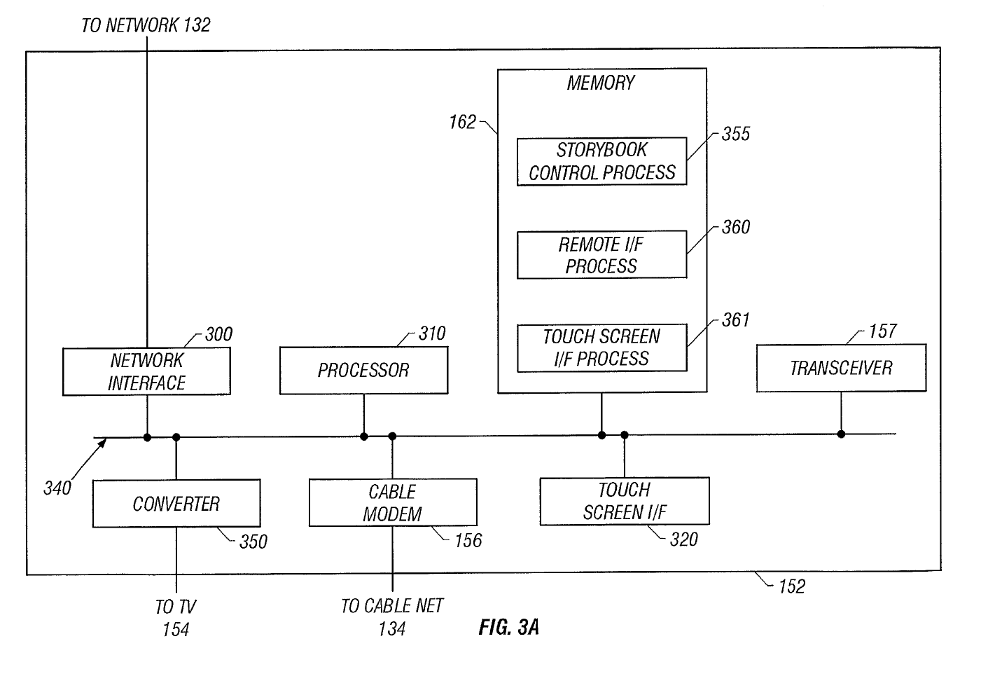

FIG. 3A illustrates a block diagram of a representative set top box in a specific embodiment of the present invention. It is noted that the set top box 152 described below is representative of some of the possible embodiments of the set top box 152 shown in FIGS. 2A-2D. The set top box 152 includes a network interface 300, processor 310, memory device 162 (also referred to as a storage device), transceiver 157, converter 350, touch screen interface 320, and cable modem 156, interconnected together for communication via system bus 340. Network interface 300 connects the set top box 152 to the cable network 134 in FIGS. 2A-2D. In alternative embodiments, the cable modem 156 or the converter 350 may provide some or all of the functionality of the network interface 300, and thus, the cable modem 156 and/or converter 350 may be omitted. In other embodiments, the network interface 300 may also provide some or all of the functionalities of the converter 350 and cable modem 156, and as a result, the converter 350 and cable modem 156 may be omitted in these particular embodiments. Processor (controller) 310 executes instructions stored in memory 162 to perform a variety of functions, such as providing programming from the cable net 134 to the viewer, enabling the viewer to select programming from a channel favorites table, and the like, for example. In specific embodiments, memory 162 further comprises program code. For example, in a specific embodiment, a storybook control process 355 that provides electronic information in interactive format over television 154 can reside within the memory 162. Storybook control process 355 provides control and direction for the resources that provide an interactive media experience to viewers of the television 154. Accordingly, in specific embodiments, storybook control process 355 may provide interactive learning, educational, entertainment, interactive children's storybooks, or other types of interactive experiences. A remote I/F process 360 controls interactions with the remote control device 158. A touch screen interface process 361 controls communications with the touch screen via touch screen I/F 320. Program processes (not shown) that control receiving of inputs from the viewer via one or more other types of interfaces, such as touch screen affixed to the remote control device 158 may also reside in memory 162. Further, not all of the program processes depicted in the representative embodiment illustrated in FIG. 3A need be present in all embodiments. In some specific embodiments, processor 310 also performs other functions within the set top box 152 not enumerated here. Further, in other embodiments, some of the functions described here will not be included.

Transceiver 157 can include an IR or RF transceiver that can exchange signals with a remote control unit 158 or other user input device. Converter 350 can convert, if necessary, digitally encoded broadcasts to a format usable by TV 154. In addition, converter 350 can convert other data received in an out-of-band portion of a broadcast. For example, television-scheduling information can be converted to a format that can be stored in memory 162.

Cable modem 156 can transmit and receive digital information, such as television scheduling information, if not included in the out-of-band portion of a broadcast. In alternative embodiments, cable modem 156 may be a conventional modem for use over telephone lines or may include any other components or modules for transmitting and receiving digital data.

FIG. 3B illustrates a block diagram of another representative set top box in a specific embodiment of the present invention. As illustrated by FIG. 3B, a computing system 200 can embody one or more of the elements illustrated by FIGS. 1A-1B, 2A-2D in various specific embodiments of the present invention. While other application-specific alternatives might be utilized, it will be presumed for clarity sake that the elements comprising the computer system 200 are implemented in hardware, software or some combination thereof by one or more processing systems consistent therewith, unless otherwise indicated.

Computer system 200 comprises elements coupled via communication channels (e.g. bus 390) including one or more general or special purpose processors 370, such as a Pentium® or Power PC®, digital signal processor (“DSP”), and the like. System 200 elements also include one or more input devices 372 (such as a mouse, keyboard, microphone, pen, and the like), and one or more output devices 374, such as a suitable display, speakers, actuators, and the like, in accordance with a particular application.

System 200 also includes a computer readable storage media reader 376 coupled to a computer readable storage medium 378, such as a storage/memory device or hard or removable storage/memory media; such devices or media are further indicated separately as storage device 380 and memory 382, which can include hard disk variants, floppy/compact disk variants, digital versatile disk (“DVD”) variants, smart cards, read only memory, random access memory, cache memory, and the like, in accordance with a particular application. One or more suitable communication devices 384 can also be included, such as a modem, DSL, infrared or other suitable transceiver, and the like for providing inter-device communication directly or via one or more suitable private or public networks that can include but are not limited to those already discussed.

Working memory further includes operating system (“OS”) elements and other programs, such as application programs, mobile code, data, and the like for implementing system 200 elements that might be stored or loaded therein during use. The particular OS can vary in accordance with a particular device, features or other aspects in accordance with a particular application (e.g. Windows, Mac, Linux, Unix or Palm OS variants, a proprietary OS, and the like). Various programming languages or other tools can also be utilized, such as known by those skilled in the art. As will be discussed, embodiments can also include a network client such as a browser or email client, e.g. as produced by Netscape, Microsoft or others, a mobile code executor such as a Java Virtual Machine (“JVM”), and an application program interface (“API”), such as a Microsoft Windows compatible API. (Embodiments might also be implemented in conjunction with a resident application or combination of mobile code and resident application components.)

One or more system 200 elements can also be implemented in hardware, software or a suitable combination. When implemented in software (e.g. as an application program, object, downloadable, servlet, and the like in whole or part), a system 200 element can be communicated transitionally or more persistently from local or remote storage to memory (or cache memory, and the like) for execution, or another suitable mechanism can be utilized, and elements can be implemented in compiled or interpretive form. Input, intermediate or resulting data or functional elements can further reside more transitionally or more persistently in a storage media, cache or more persistent volatile or non-volatile memory, (e.g. storage device 380 or memory 382) in accordance with a particular application.

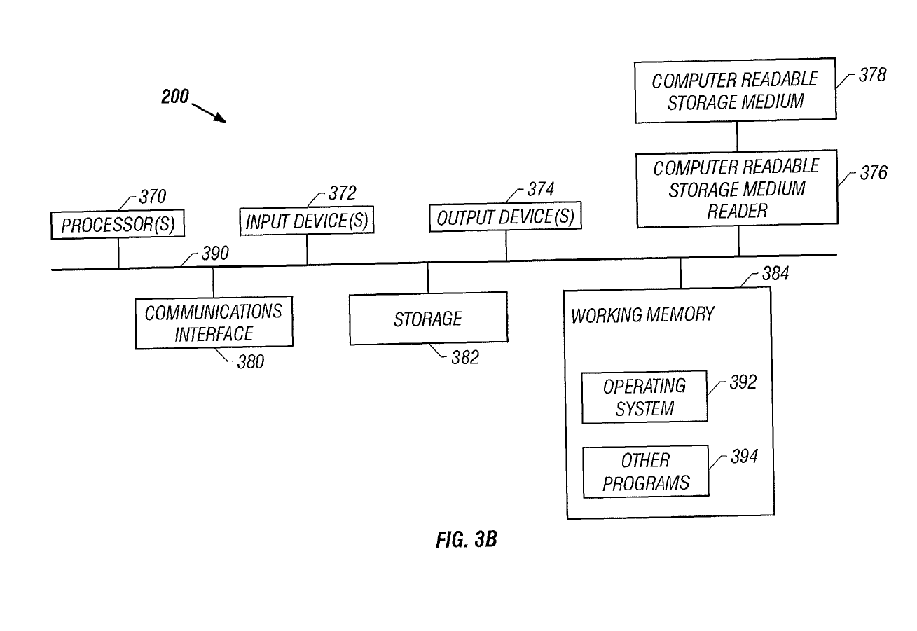

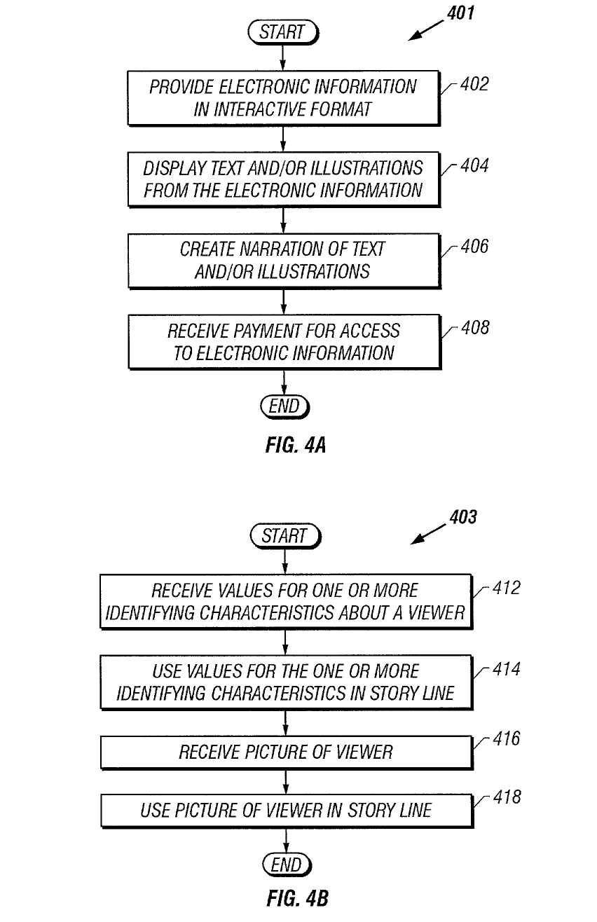

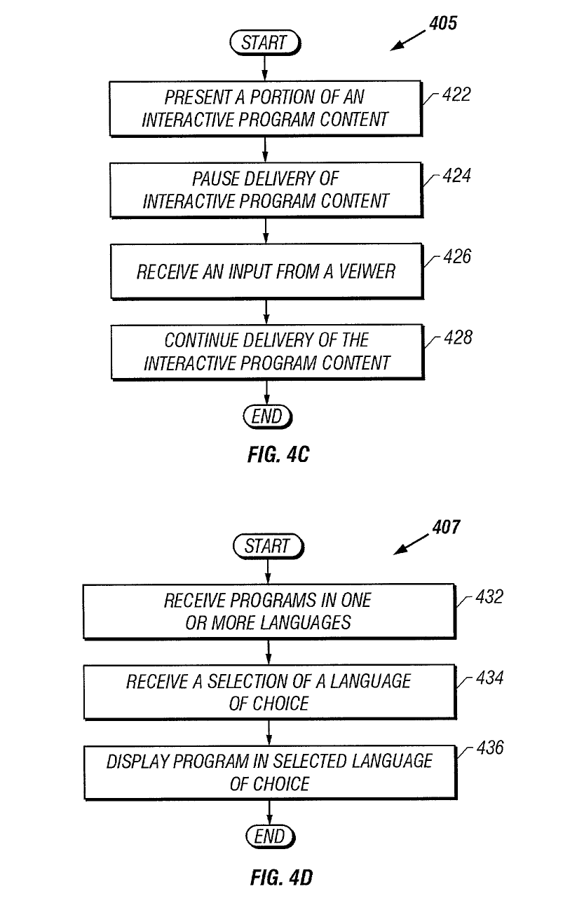

FIG. 4A illustrates a flowchart of a representative technique for providing electronic format information in a specific embodiment of the present invention. As shown by flowchart 401, a specific embodiment includes a method that comprises providing electronic information in an interactive format 402. In specific embodiments, the interactive electronic information may be viewed using a television, for example. Then, text and/or illustration from the electronic information is displayed 404 and a narration of the text and/or illustrations is made 406. In specific embodiments, the narration may be made substantially contemporaneously with displaying the text. In some embodiments, the text and narration may be played independently of one another according to the wishes of a viewer. The flowchart 401 also illustrates receiving a payment for accessing the electronic information 408. In a further distinction from conventional approaches, the present invention in specific embodiments provides the capability for the payment to comprise a rental charge for accessing the electronic information, as well as in embodiments wherein the payment is for a purchase. This figure is merely representative of some of the many achievable embodiments enabled by the present invention. Variations, modifications, and substitutions exist, as will be readily apparent to those skilled in the art.

FIG. 4B illustrates a flowchart of a representative technique for providing electronic format information in a specific embodiment of the present invention. As shown by flowchart 403, in a specific embodiment, electronic information comprises one or more fields. The one or more fields are disposed to receive values for identifying various things 412. One characteristic that can be populated into these fields is information characterizing a viewer, such as name, age, name of friends, and so forth. Then, the value of the viewing child's name can be used in various places within the story line 414. For example, a name of a child viewer may be populated into one or more fields identifying a child's name. In other specific embodiments, other types of information may be stored in the fields and added to the story. For example, in a specific embodiment, optionally, a picture of a child viewing the electronic information being displayed may be taken and stored in a digitized format. The digitized picture can be received into a field 416. The picture is then inserted into a story line within the electronic information being displayed 418. In a specific embodiment, the “me2cam” by Intel Corporation is used to take a picture of the child or children. However, other cameras and image digitizing software can also be used in various specific embodiments.

FIG. 4C illustrates a flowchart of a representative technique for providing electronic format information in a specific embodiment of the present invention. As shown by flowchart 405, a specific embodiment includes a method that comprises presenting a portion of an interactive program content to a viewer 422. For example, an educational program can provide a problem to be solved to the student viewer. A Personal Video Recorder (PVR) can deliver the interactive program content, for example. The interactive program content is paused 424. This pause allows the student, for example, to work on the problem before viewing an answer. Then, an input is received from the viewer 426. The input can be in the form of indicating a selection of an answer choice on the television screen via a touch screen mechanism, or other means. Then, delivery of the interactive program content can be continued 428. In some specific embodiments, one or more triggers may be embedded into a broadcast program content to cause a PVR to pause program, for example. Then, the viewers may interact with the program at their own pace. Subsequently, the viewers may continue to view a subsequent part of the program.

FIG. 4D illustrates a flowchart of a representative technique for providing electronic format information in a specific embodiment of the present invention. As shown by flowchart 407, a specific embodiment includes a method that comprises receiving programs in one or more languages 432. Programs may be received via an IP channel, for example. A selection of a language of choice is received from a viewer, for example 434. Then, the programs may be displayed in the language of choice 436.

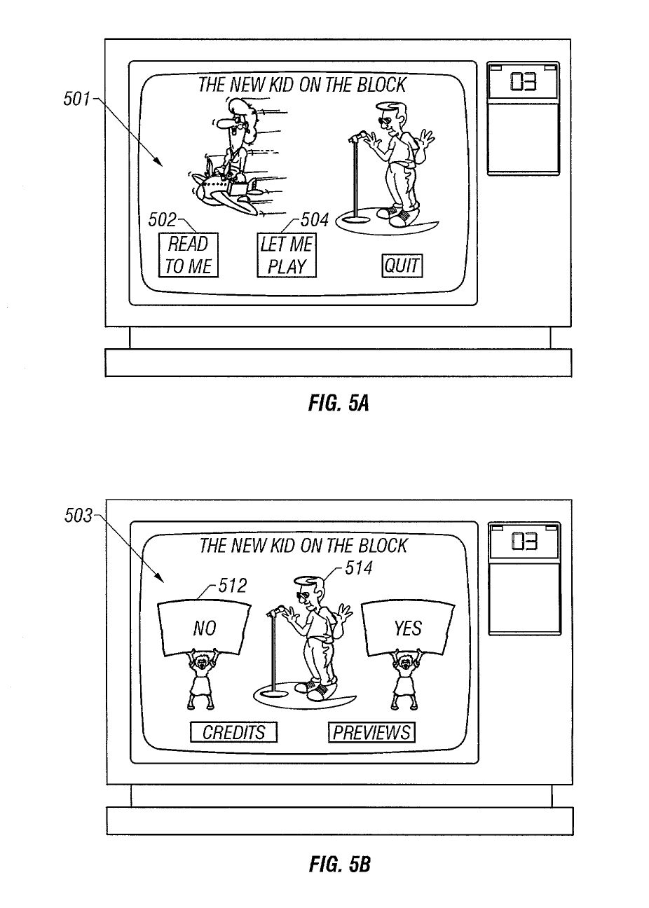

FIG. 5A illustrates a representative screen display in a specific embodiment of the present invention. As shown in FIG. 5A, a screen display 501, which may be displayed on a screen of television 154, for example, depicts an excerpt from a representative interactive program content. Selecting a “Read to me,” button 502, either by touching, or moving very close to a portion of the screen depicting the words “read to me,” will recite a story continuously without interruption. Selecting a “Let me play,” button 504 allows for stopping and starting the story and selecting words to be repeated or illustrated. The images depicted herein are not intended to represent any specific type of story, but rather are provided to more generally illustrate the concepts underlying specific embodiments of the present invention.

FIG. 5B illustrates another representative screen display in a specific embodiment of the present invention. As shown in FIG. 5B, a screen display 503 demonstrates the use of moving pictures to convey information to a child. Here, a character 512 shakes his head for “yes” and “no”. A story-teller character 514 asks “Are you sure you want to quit?” In some specific embodiments, the words may be provided as text and/or pronounced verbally via an audio sub-system. The images depicted herein are not intended to represent any specific type of story, but rather are provided to more generally illustrate the concepts underlying specific embodiments of the present invention.

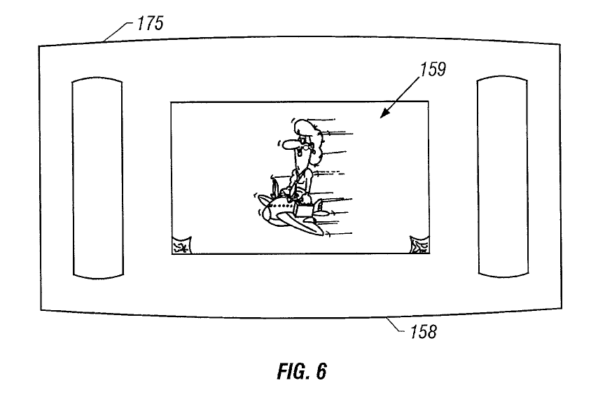

FIG. 6 illustrates a diagram of a representative remote control device in a specific embodiment of the present invention. As shown in FIG. 6, a remote control device 158 comprises one or more handles 175 that enable a child to easily grasp the device. Further, a screen display 159 having a touch sensitive or presence sensitive capability enables the child to interact with the program content being displayed. In a present specific embodiment, remote device 158 can be a wireless device that is small enough for a child to hold in his or her lap. The screen displays an image that duplicates what is displayed on the television 154. The touch sensitive screen display 159 can be used to emulate mouse functions. A young child can touch a word displayed on the screen display 159 in order to have it repeated and/or illustrated, or touch arrows, or other icons, to advance the page. Another touch control can be added to exit the story.

In a specific embodiment, the technique may also include selecting audio and text overlays based upon the selection of a language of choice. In another specific embodiment, the television may be tuned by receiving a selection made from one or more of on-screen choices. In a yet further specific embodiment, the technique further includes selecting text in an on-screen overlay based upon the selection of a language of choice. In another specific embodiment, receiving an input comprising a touch and using the input in commerce are provided. For example, in one implementation, a Wink “i” button may be activated to initiate a transaction. In another specific embodiment, receiving an input comprising a touch and showing a meaning of a word corresponding to a location of the touch can also be provided. In such embodiments, an “on-line” dictionary is provided using a touch sensitive interface to the television screen, for example.

In the description herein, numerous specific details are provided to provide a thorough understanding of embodiments of the invention. One skilled in the relevant art will recognize, however, that the invention can be practiced without one or more of the specific details, or with other methods, components, materials, parts, and the like. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing teaching. Further, the systems and methods described above may be used for interactive television, which may include broadcasting, demand casting, multi-casting, uni-casting, and other various technologies. Further, at least some of the components of this invention may be implemented by using a programmed general-purpose digital computer, by using application specific integrated circuits, or by using a network of interconnected components and circuits. Connections may be wired, wireless, by modem, and the like.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A system, comprising:
a television; and
a presence sensitive device;
wherein said television has a display screen;
wherein said presence sensitive device is operatively disposed in relation to said display screen; and
wherein said presence sensitive device is operative to determine a selection of at least one of a plurality of items displayed on said display screen based upon sensing a presence.

2. The system of claim 1,
further comprising:
an interface that receives interactive programming content;
wherein said interactive programming content is displayed on said display screen;
wherein input is received from said presence sensitive device; and
wherein said input is used to interact with said interactive programming content.

3. The system of claim 1,
wherein said television is communicatively coupled with at least one of a plurality of content providers.

4. The system of claim 3,
wherein said at least one of a plurality of content providers includes at least one of:
an Internet web site;
a cable television content provider; and
a satellite television content provider.

5. The system of claim 2,
wherein said interactive programming content comprises at least one of:
an electronic program guide;
an electronic program guide for children;
an on-screen control for television;
an on-screen control for a displayed cursor;
an on-screen control for VCR;
an interactive game;
interactive educational instruction;
interactive foreign language instruction; and
interactive decision making for creating a story.

6. The system of claim 1,
wherein said presence sensitive device provides an input which emulates a mouse.

7. The system of claim 6,
wherein said input which emulates a mouse enables children to use the web.

8. The system of claim 1,
further comprising a pointing device;
wherein said pointing device provides an interface for a physically impaired person.

9. The system of claim 1,
wherein said presence sensitive device provides an alternate control set for remote control.

10. The system of claim 2,
wherein said television provides narration for said interactive programming content.

11. The system of claim 10,
wherein said narration comprises text to speech conversion of a book.

12. The system of claim 10,
wherein said television controls tone and/or accent of narration according to an input.

13. The system of claim 10,
wherein said television controls speed of narration according to an input.

14. The system of claim 13,
wherein said input is received from a user.

15. The system of claim 1,
wherein said presence sensitive device includes at least one of:
a touch screen;
a capacitive touch screen;
a surface acoustic wave (SAW) touch screen;
a wire resistive touch screen; and
a stylus based selection indication mechanism.

16. The system of claim 1,
wherein said presence sensitive device provides at least one of:
control of cursor movement;
control of a selection rectangle;
control of a navigational aid; and
control of a selection aid.

17. The system of claim 1,
wherein a user communicates with said television via said presence sensitive device.

18. The system of claim 1,
further comprising:
a remote control device;
wherein said remote control device includes a second display screen;
wherein at least one of a plurality of commands are exchanged between said remote control device and said television;
wherein said remote control device includes a second presence sensitive device; and
wherein said second presence sensitive device is operatively disposed in relation to said second display screen.

19. The system of claim 1,
further comprising:
a device for playing interactive programming content on the television.

20. The system of claim 19,
wherein said device for playing interactive programming content includes at least one of:
a VCR;
a DVD player;
a CD player;
a PVR;
a Nintendo;
a Playstation;
a set top box; and
a head end computer.

21. The system ofclaim 19,
wherein said interactive programming content includes at least one of:
an electronic program guide;
an electronic program guide for children;
interactive games;
a children's story book;
an interactive story book, in which a story is created based upon decisions received from a user;
an educational material; and
foreign language instruction material.

22. A method, comprising:
providing electronic information in an interactive format via a television system;
displaying text and/or illustration from said electronic information;
providing a narration of said text substantially contemporaneously with displaying said text; and
receiving a payment for accessing said electronic information;
wherein said payment comprises a rental charge for accessing said electronic information.

23. The method of claim 22,
wherein said electronic information comprises at least one of a plurality of fields; and
wherein said at least one of a plurality of fields is disposed to receive values for identifying characteristics about a viewer.

24. The method of claim 23,
wherein said method further comprises:
populating at least one of said plurality of fields with a name of a child viewing the electronic information being displayed.

25. The method of claim 22,
further comprising:
taking a picture of a child viewing the electronic information being displayed; and
inserting said picture into a story line within said electronic information being displayed.

26. The method of claim 22,
further comprising:
presenting a problem to be solved in an interactive program content delivered by a Personal Video Recorder (PVR);
pausing said interactive program content to go into interactive mode;
determining an answer to said problem presented; and
receiving an input comprising a touch of a selected answer.

27. The method of claim 26,
further comprising:
embedding into a broadcast program content at least one of a plurality of triggers to cause a PVR to pause program;
allowing a viewer to interact with said program at own pace; and
continuing to a subsequent part of said program.

28. The method of claim 22,
further comprising:
receiving at least one of a plurality of foreign language audio programs via an IP channel;
receiving from a viewer a selection of a language of choice; and
receiving both an audio program and said text in said language of choice.

29. The method of claim 28,
further comprising:
selecting audio and text overlays based upon said selection of a language of choice.

30. The method of claim 28,
further comprising:
tuning said television by receiving a selection made from at least one of a plurality of on-screen choices.

31. The method of claim 28,
further comprising:
selecting text in an on-screen overlay based upon said selection of a language of choice.

32. A method,
comprising:
receiving an input comprising a touch; and
using said input in commerce.

33. A method,
comprising:
receiving an input comprising a touch; and
showing a meaning of a word corresponding to a location of said touch.

34. A computer program product, comprising:
code that provides electronic information in an interactive format via a television system;
code that displays text and/or illustration from said electronic information;
code that provides a narration of said text substantially contemporaneously with displaying said text; and
code that receives a payment for accessing said electronic information;
wherein said payment comprises a rental charge for accessing said electronic information; and
a computer readable storage medium for holding the code.

35. The computer program product of claim 22,
wherein said electronic information comprises at least one of a plurality of fields; and
wherein said at least one of a plurality of fields is disposed to receive values for identifying characteristics about a viewer.

36. The computer program product of claim 23,
wherein said computer program product further comprises:
code that populates at least one of said plurality of fields with a name of a child viewing the electronic information being displayed.

37. The computer program product of claim 22,
further comprising:
code that takes a picture of a child viewing the electronic information being displayed; and
code that inserts said picture into a story line within said electronic information being displayed.

38. The computer program product of claim 22,
further comprising:
code that presents a problem to be solved in an interactive program content delivered by a Personal Video Recorder (PVR);
code that pauses said interactive program content to go into interactive mode;
code that determines an answer to said problem presented; and
code that receives an input comprising a touch of a selected answer.

39. The computer program product of claim 26,
further comprising:
code that embeds into a broadcast program content at least one of a plurality of triggers to cause a PVR to pause program;
code that allows a viewer to interact with said program at own pace; and
code that continues to a subsequent part of said program.

40. The computer program product of claim 22,
further comprising:
code that receives at least one of a plurality of foreign language audio programs via an IP channel;
code that receives from a viewer a selection of a language of choice; and
code that receives both an audio program and said text in said language of choice.

41. The computer program product of claim 28,
further comprising:
code that selects audio and text overlays based upon said selection of a language of choice.

42. The computer program product of claim 28,
further comprising:
code that tunes said television by receiving a selection made from at least one of a plurality of on-screen choices.

43. The computer program product of claim 28,
further comprising:
code that selects text in an on-screen overlay based upon said selection of a language of choice.

44. A computer program product,
comprising:
code that receives an input comprising a touch;
code that uses said input in commerce; and
a computer readable storage medium for holding the code.

45. A computer program product,
comprising:
code that receives an input comprising a touch;
code that shows a meaning of a word corresponding to a location of said touch; and
a computer readable storage medium for holding the code.

46. An apparatus,
comprising:
one or more handles;
a screen display;
a touch sensitive input device; and
a means for communicating with a set top device;
wherein said touch sensitive device is disposed proximately to said screen display in order to allow interaction with a program content being displayed via touch.

47. The apparatus of claim 46,
wherein said communicating is wireless.

48. The apparatus of claim 46,
wherein said screen displays an image that duplicates an image displayed on a television.

49. The apparatus of claim 46,
wherein said touch sensitive input device emulates mouse functions.
